(19) United States
(12) Patent Application Publication
(10) Pub. No.: US 2004/0159331 A1
(43) Pub. Date: Aug. 19, 2004

(54) Cleaning tool for mechanical components

(76) Inventor: Daniel H. Katsin, Mill Valley, CA (US)

Correspondence Address: Samuel S. Lee, DERGOSITS & NOAH LLP, Four Embarcadero Center, Suite 1450, San Francisco, CA, 94111, US

(21) Appl. No.: 10/370,682

(22) Filed: Feb. 19, 2003

(51) Int. Cl. B08B 7/00

(52) U.S. Cl. 134/6; 15/210.1; 15/104.16

(57) ABSTRACT

The present invention is directed to a cleaning apparatus and a method of for using the apparatus to remove foreign matter, e.g., dirt, dust, accumulated lubricant, moisture and the like, from the areas in and around a mechanical component having a void space. The cleaning apparatus includes an elongated flexible member terminated by first and second ends, and a tapered end disposed on at least one of the ends of the elongated member. The apparatus can be threaded into the void space and contacted with a surface of the void space.

### FIELD OF INVENTION

The present invention relates to an apparatus for cleaning mechanical parts. In particular, the present invention relates to an apparatus for cleaning mechanical parts having difficult to reach surface areas.

### BACKGROUND OF THE INVENTION

Over the last three decades recreational and transportation devices, such as bicycles and motorcycles, have grown more complex with increasing mechanical precision. As a result, their functionality, reliability and safe operation have become more dependent on consistent performance of all of the interrelated parts at optimum specified levels. This has increased the need for each component to be kept free of the debris, which typically accumulates as a result of normal use. In the past, household rags and various kinds of brushes were sufficient to clean the gears of many bicycles and motorcycles. However, increasing engineering precision and complexity of components has created a need for special tools for proper cleaning. The present invention provides an apparatus and a method of using the apparatus to meet this need.

### SUMMARY OF THE INVENTION

The present invention is directed to an apparatus and a method for using the apparatus for cleaning a mechanical component with a void space. The apparatus includes an elongated flexible member terminated by first and second ends, and a tapered end disposed on at least one of the ends of the elongated member. The flexible member is preferably made of a woven microfiber material, and the tapered end can be made of a resilient material. A tapered end can be disposed on both the first and second ends of the elongated member so that the two tapered ends may have the same or different geometric shapes. In addition, the two tapered ends can have different connections to the ends of the elongated members. The tapered end preferably has an operational end portion that is configured to assisting in cleaning, such as a pick. The operational end portion can be configured to provide a surface capable of retaining and dispensing a cleaning fluid onto a void space surface.

The apparatus can be effectively utilized to perform a method of cleaning a mechanical component with a void space. The method includes threading a cleaning apparatus, described above, into the void space of a mechanical component, and contacting the flexible member against a void space surface. The threading step can include applying a motion selected from the group consisting of: using a tapered end like a needle to thread the cleaning apparatus into the void space; holding any portion of the elongated flexible member taut with thumbs and forefingers and guiding the portion of the elongated flexible member into the void space; and any combination thereof. The contacting step can include applying a motion selected from the group consisting of: moving any portion of the flexible member through the void space; moving any portion of the flexible member in a back and forth motion through the void space; moving the flexible member in a flossing motion; and any combination thereof. The method can further include applying a suitable cleaning fluid to the flexible member, a void space surface of the mechanical component, or a combination thereof. The method can also further include removing foreign matter from a void space surface of a mechanical component with the tapered end.

### BRIEF DESCRIPTION OF THE DRAWINGS

While the specification concludes with claims particularly pointing out and distinctly claiming the subject matter, which is regarded as defining the present invention, it is believed that the invention will be better understood from the following description taken in conjunction with the following accompanying drawings:

FIG. 1 is an illustration of one embodiment of the present invention;

FIG. 2 is a cross-section view along axis X-X of the embodiment illustrated in FIG. 1; and

FIG. 3 is an illustration of an end portion of one embodiment of the present invention.

### DETAILED DESCRIPTION OF THE INVENTION

The present invention provides an apparatus and a method for using the apparatus to remove foreign matter, e.g., dirt, dust, accumulated lubricant, moisture and the like, from the areas in and around a mechanical component having a void space. A mechanical component having a void space, as used herein, means any mechanical part that has surface areas forming one or more interior spaces through which the apparatus of the present invention can be passed to clean the surface areas. The surface areas forming the void spaces are also referred to herein as void space surfaces. Examples of such mechanical components include, but are not limited to, bicycle parts, such as rear cogs, rear derailleurs, front and rear brakes, frame pivots, and suspension components.

The cleaning apparatus includes an elongated flexible member terminated by first and second ends, and a tapered end disposed on at least one of the ends of the elongated member. The shape and geometry of the invention is selected so that the apparatus can be threaded into and contacted with the void space surfaces of the mechanical components.

The elongated flexible member can be made of any water insoluble material that is useful for removing foreign matter from the void space surfaces of the mechanical component. The elongated flexible member is preferably also insoluble in any of the solvent typically used in cleaning mechanical components. The elongated flexible member is preferably made of a woven material, which can be chosen to provide one or more functionalities, such as absorbency, scrubbing ability, and resilience. The woven layer is more preferably made of a synthetic fiber having a denier of from about 0.01 to about 50. The woven layer is most preferably made of a synthetic fiber having a denier of from about 0.01 to about 0.99. The woven layer can be made of a split microfiber, unsplit microfiber, or a combination thereof. The loop size can be selected to be small enough to prevent tangling in the features of the mechanical component being cleaned. Examples of suitable materials include, but are not limited to, wovens made from natural fibers, such as cotton, silk, linen, and combinations thereof, and wovens made from synthetic fibers, such as polyester, polyamide (nylon), rayon, acrylic, and combinations thereof. Nonlimiting examples of useful materials include: microfibers, such as MFT 1, 2, 3, 5, 11.3, and 35, which are commercially available from Leading Edge Products located in San Diego, Calif.; microfibers made with polyester and polyamide in a weight percentage ratio ranging from about 50/50 to about 90/10; microfibers made from 100% polyester; and microfibers made from 100% polyamide (nylon). Wovens can be obtained from any combination of the fibers described above, wherein the fibers have a weight from about 35 grams to about 850 grams/m².

The elongated flexible member has at least two ends and preferably has sufficient surface area for contacting the void space surfaces of the mechanical component. Accordingly, the elongated flexible member can be configured to have a length and a cross section tailored for maximum cleaning of the void space surfaces of a mechanical component. Typically, the elongated flexible member has a length from about 10 cm to about 70 cm, preferably from about 10 cm to about 55 cm.

The elongated flexible member can be configured to have a cross section that is solid or tubular. The cross section can also be configured into any geometrically desirable shape. When the elongated flexible member is configured to be a strip of a woven material, the cross section has a height from about 0.5 cm to about 5.0 cm, preferably from about 1.0 cm to about 3.0 cm, and a width (thickness) from about 0.05 cm to about 2.0 cm, preferably from about 0.1 cm to about 1.0 cm. The width of can be adjusted as desired by any known method known in the art. For example, the width can be adjusted by attaching together multiple strips of material having the same dimensions. Alternatively, a strip of material can be folded along its length to form a U-shaped cross section, thereby doubling the width and halving the height.

When the elongated flexible member is configured to have a substantially round configuration (e.g., by utilizing a rope-like cross section or by forming a tubular cross section), the cross section has diameter from about 1.0 cm to about 5.0, preferably from about 0.5 cm to about 2.5 cm. The elongated flexible member can also be formed into a tubular configuration by any method known in the art. For example, the elongated flexible member can be woven into a tubular configuration. Alternatively, a tubular configuration can be obtained by attaching the edge of one long side to the edge of the second long side of a rectangular strip of material.

A tapered end is disposed on at least one of the ends of the elongated member. The tapered end can provide at least two functions: it can assist in threading the apparatus into and through the void spaces of the mechanical component, such as a needle and thread; and it can also be configured to have an operational end portion that can be used to pick away and remove foreign matter from the intricacies of the void space surfaces. Accordingly, the tapered end can be made of any resilient material (e.g., strong enough for use as a pick) known in the art. Examples of suitable materials include, but are not limited to, plastics, such as acrylonitryl butadiene styrene (ABS), polystyrene, polyethylene, polypropylene, and the like; and metals, such as, aluminum, steel, alloys, and the like.

The tapered end can be formed into any desired shape for enhanced functionality. When a tapered end is disposed on both ends of the elongated flexible member, the two tapered ends may have the same or different shape. In order to increase access into and through a void space, it is also preferred to maintain the cross section dimensions of the tapered end (e.g., width, height, and cross section area) to be substantially equivalent to or less than the cross section dimensions of the elongated flexible member.

An operational end portion of the tapered end is preferably formed to provide an acute point to promote utilization as a pick. Nonlimiting examples of useful shapes for the operational end portion include a prismatoid, a wedge or lune, a cone, a pyramid, and a hook. Other useful shapes for the operational end portion can be found in the dental instrument arts, especially dental picks, which utilize operational tips optimally shaped for picking and probing. Suitable dental instrument like shapes for the operational end portion can be found in U.S. Pat. No. 4,913,176, which is incorporated herein by reference in its entirety. For example, the operation end portion can have any of the following dental instrument shapes: a rounded bulbous head; a head having a sinusoidol upper hemisphere edge and a rounded lower hemisphere edge; a partially rounded, substantially hexagonal head ; and a continuous elongated pin. The tapered end can also be formed to have an operational end capable of retaining and dispensing a cleaning fluid onto a void space surface. For example, a depression or a hole can be formed in any of the above shapes for the operational end.

The tapered end can be disposed on one or more ends of the elongated flexible member by any method known in the art. When a tapered end is disposed on both ends of the elongated flexible member, the two tapered ends can be disposed on each end using the same or different method. In one embodiment, the tapered can be fixedly attached to an end of the flexible member, e.g., by using a suitable adhesive, stitching or staples. Alternatively, the tapered end can be enveloped by the elongated flexible member (e.g., one having a tubular or U-shaped cross section) and held in place with suitable adhesive, stitching or staples. The tapered end can also be formed around and onto an end of the flexible member, e.g., in a plastic molding process. In another embodiment, the tapered end can be removably attached to an end of the flexible member, e.g., by using a suitable clip. For example, a locking binder clip may be used to attach the tapered end to an end of the elongated flexible member. Alternatively, the tapered end can be manufactured to include a locking binder clip.

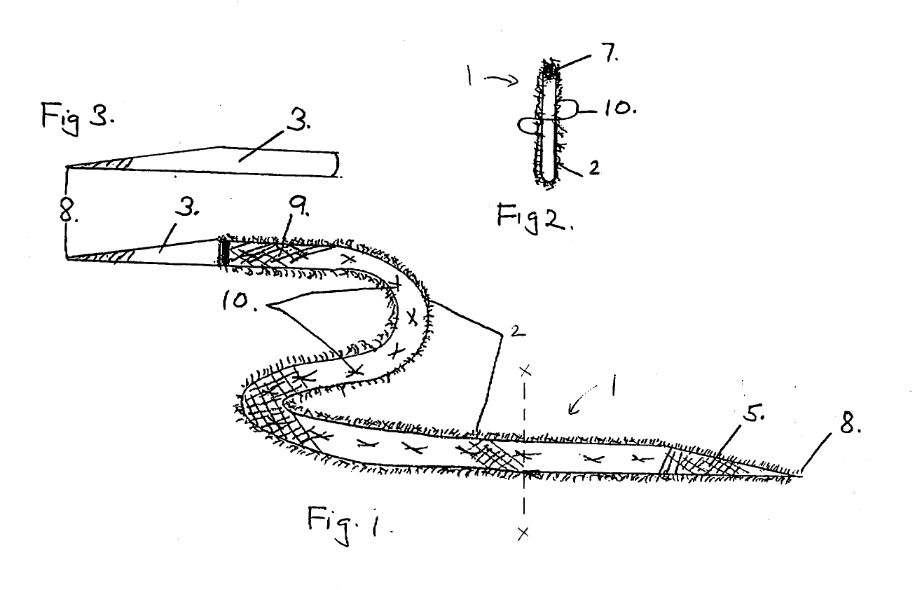

As illustrated in FIG. 1, one embodiment of the present cleaning apparatus 1 includes an elongated flexible member 2 with a tapered end 3 disposed on both ends of the elongated member. The elongated flexible member is about 53 cm long and is made of a medium-short terry cloth, double or single knit microfiber, which was obtained as microfiber MFT 11.3 from Leading Edge Products located in San Diego, Calif. The elongated flexible member is configured to provide a tubular cross section by sewing the long edges together 7, as illustrated in FIG. 2. The tubular cross section can be modified by sewing cross-stitching 10 along the center longitudinal axis, as illustrated in FIGS. 1 and 2. The resulting cross-stitched elongated flexible member has a height of about 3 cm and a width of about 0.3 cm.

The tapered end 3 disposed on each end of the elongated flexible member is made of styrene plastic and has a length of about 7.5 cm, a height of about 1.5 cm. and a width of about 2.0 mm. As illustrated in FIG. 3, the tapered end 3 is formed into a trapezoid-like shape with a leg forming an acute angle with the longer base of the trapezoid, and a leg forming a substantially right angle with both bases of the trapezoid. The acute angle formed provides a point 8 to serve as the operational end portion of the tapered end 3. The tapered end 3 can also be described as a 3 cm×4.5 cm rectangle with a right triangle extending from one of the short ends of the rectangle, wherein the triangle has about a 1.5 cm base, about a 3 cm right side, and about a 3.75 cm hypotenuse. In addition, the corners of the tapered end attaching to the elongated flexible member can be slightly rounded for easier assembly. The tapered end can be attached to the elongated flexible member by spot gluing with a suitable adhesive, e.g., a solvent-resistant adhesive, to form a joint 9. The operational end portion of the tapered end, e.g., the right triangle end, can be exposed. Alternatively, the entire tapered end portion can be covered 5 by one end of the elongated flexible member.

The present invention is also directed to a method of cleaning a mechanical component having a void space. The method can effectively remove accumulated foreign matter, such as dirt, dust, sand, water, and lubricant from the void space. The method includes (i) threading the cleaning apparatus described above into the void space of a mechanical component, and (ii) contacting the flexible member against a void space surface. The method can further include the step of applying a suitable cleaning fluid to the flexible member, a void space surface of the mechanical component, or a combination thereof.

The cleaning apparatus 1 can be threaded into the void space by utilizing any suitable threading motion. For example, the treading motion can include any one or a combination of the following motions: (i) using a tapered end 3 like a needle to thread the cleaning apparatus into the void space, e.g., utilizing a threading motion similar to using a needle and thread; and (ii) holding any portion of the elongated flexible member 2 taut with thumbs and forefingers and guiding the portion of the elongated flexible member into the void space, e.g., utilizing a zig-zag, sawing, or snap motion similar to guiding dental floss in between teeth.

After the apparatus is threaded or placed into the void space, the elongated flexible member 2 can be contacted with a void space surface by utilizing any suitable contacting motion. For example, the contacting motion can include any one or a combination of the following motions: (i) moving the entire length of the flexible member, or any portion thereof, through the void space, e.g., by pulling one end of the elongated flexible member; (ii) moving the entire length of the flexible member, or any portion thereof, in a back and forth motion through the void space; and (iii) moving the flexible member in a flossing motion, e.g., similar to contouring floss around a surface of a tooth and scraping the surface of the tooth by moving the floss up and down against the surface of the tooth.

The method can also further include the step of removing foreign matter from a void space surface of a mechanical component with the tapered end. As described above, the tapered end portion can be used to pick, scrape, disrupt, or loosen the foreign matter attached to any irregular void space surface, such as a crevice. Preferably, the operational end portion of the tapered end is formed to provide an acute point (e.g., a tip or dental instrument like end) to promote utilization as a pick.

In order to enhance removal of foreign matter, this method can further include the step of applying a suitable cleaning fluid to a tapered end, a void space surface of the mechanical component, or a combination thereof. Application of a cleaning fluid can be aided by tailoring the tapered end. For example, a tapered end can be covered with a material capable of absorbing the cleaning fluid, e.g., enveloped by an end of the elongated flexible member (e.g., one having a tubular or U-shaped cross section), as described above. Alternatively, the tapered end can be formed to have an operational end capable of retaining and dispensing a cleaning fluid onto a void space surface, as described above.

After use, the cleaning apparatus may be cleaned by hand or machine-washed. Alternatively, the apparatus may be used until it is worn out and then disposed.

What is claimed is:

1. An apparatus for cleaning a mechanical component with a void space, the apparatus comprising:
an elongated flexible member terminated by first and second ends, wherein the flexible member is made of a woven microfiber material; and
a tapered end disposed on at least one of the ends of the elongated member.

2. The apparatus according to claim 1, wherein a tapered end is disposed on both the first and second ends of the elongated member.

3. The apparatus according to claim 2, wherein the two tapered ends may have different geometric shapes.

4. The apparatus according to claim 2, wherein the two tapered ends have different connections to the ends of the elongated members.

5. The apparatus according to claim 1, wherein the tapered end is formed into a shape selected from the group consisting of a prismatoid, a wedge, a lune, a cone, a pyramid, a hook, and any combination thereof.

6. The apparatus according to claim 1, wherein a tapered end may be covered with a material capable of absorbing cleaning fluid.

7. The apparatus according to claim 1, wherein the tapered end has an operational end portion.

8. The apparatus according to claim 7, wherein the operational end is configured into a shape selected from the group consisting of an acute point and a dental pick.

9. The apparatus according to claim 8, wherein the operation end is configured into a shape selected from the group consisting of a rounded bulbous head, a head having a sinusoidol upper hemisphere edge and a rounded lower hemisphere edge, a partially rounded, substantially hexagonal head, a continuous elongated pin, and combinations thereof.

10. The apparatus according to claim 7, wherein the operational end is configured to provide a surface capable of retaining and dispensing a cleaning fluid onto a void space surface.

11. The apparatus according to claim 1, wherein the tapered end is made of a resilient material.

12. The apparatus according to claim 11, wherein the resilient material is selected from the group consisting of plastics, metals, and combinations thereof.

13. The apparatus according to claim 1, wherein the tapered end is removably connected to the elongated member.

14. The apparatus according to claim 1, wherein the woven material of the flexible member is made of a synthetic fiber having a denier of from about 0.01 to about 0.99.

15. The apparatus according to claim 14, wherein the woven material is made of microfiber selected from the group consisting of a split microfiber, an unsplit microfiber, or a combination thereof.

16. A method of cleaning a mechanical component with a void space, the method comprising,
threading a cleaning apparatus into the void space of a mechanical component, the apparatus comprising,
an elongated flexible member terminated by first and second ends, and
a tapered end disposed on at least one of the ends of the elongated member; and
contacting the flexible member against a void space surface.

17. The method according to claim 16, wherein the threading step includes applying a motion selected from the group consisting of: using a tapered end like a needle to thread the cleaning apparatus into the void space; holding any portion of the elongated flexible member taut with thumbs and forefingers and guiding the portion of the elongated flexible member into the void space; and any combination thereof.

18. The method according to claim 16, wherein the contacting step includes applying a motion selected from the group consisting of: moving any portion of the flexible member through the void space; moving any portion of the flexible member in a back and forth motion through the void space; moving the flexible member in a flossing motion; and any combination thereof.

19. The method according to claim 16, wherein a tapered end is disposed on both the first and second ends of the elongated member.

20. The method according to claim 19, wherein the two tapered ends have different geometric shapes.

21. The method according to claim 20, wherein the two tapered ends may have different connections to the ends of the elongated members.

22. The method according to claim 16, wherein the tapered end is formed into a shape selected from the group consisting of a prismatoid, a wedge, a lune, a cone, a pyramid, a hook, and any combination thereof.

23. The method according to claim 16, wherein the tapered end has an operational end portion.

24. The method according to claim 23, wherein the operational end is configured into a shape selected from the group consisting of an acute point and a dental pick.

25. The method according to claim 24, wherein the operation end is configured into a shape selected from the group consisting of a rounded bulbous head, a head having a sinusoidol upper hemisphere edge and a rounded lower hemisphere edge, a partially rounded, substantially hexagonal head, a continuous elongated pin, and combinations thereof.

26. The method according to claim 16, wherein the tapered end is made of a resilient material.

27. The method according to claim 26, wherein the resilient material is selected from the group consisting of plastics, metals, and combinations thereof.

28. The method according to claim 16, wherein the tapered end is removably connected to the elongated member.

29. The method according to claim 16, wherein the elongated flexible member is made of a woven material.

30. The method according to claim 29, wherein the woven material is made of a fiber selected from the group consisting of natural fibers, synthetic fibers, and combinations thereof.

31. The method according to claim 30, wherein the woven material is made of a fiber selected from the group consisting of cotton, silk, linen, polyester, polyamide, rayon, acrylic, and combinations thereof.

32. The method according to claim 31, wherein woven material is made of a synthetic fiber having a denier of from about 0.01 to about 0.99.

33. The method according to claim 32, wherein the woven material is made of microfiber selected from the group consisting of a split microfiber, an unsplit microfiber, or a combination thereof.

34. The method according to claim 16, further comprising applying a suitable cleaning fluid to the flexible member, a tapered end, a void space surface of the mechanical component, or a combination thereof.

35. The method according to claim 34, wherein the tapered end is covered with a material capable of absorbing the cleaning fluid.

36. The method according to claim 34, wherein the tapered end is configured to provide a surface capable of retaining and dispensing a cleaning fluid onto a void space surface

37. The method according to claim 16, further comprising removing foreign matter from a void space surface of a mechanical component with the tapered end.

38. The method according to claim 37, wherein tapered end portion is used to pick, scrape, disrupt, or loosen the foreign matter attached to any irregular void space surface.
